(19) United States
(12) Patent Application Publication
(10) Pub. No.: US 2026/0069985 A1
(43) Pub. Date: Mar. 12, 2026

(54) PROCESSING DEVICES AND METHODS

(71) Applicant: Sony Interactive Entertainment Inc., Tokyo (JP)

(72) Inventors: Ryan John SPICK, London (GB); Alan Suganuma MURPHY, London (GB); Jason Craig MILLSON, London (GB); Adrian Barahona RIOS, London (GB)

(73) Assignee: Sony Interactive Entertainment Inc., Tokyo (JP)

(21) Appl. No.: 19/320,276

(22) Filed: Sep. 5, 2025

(30) Foreign Application Priority Data
Sep. 6, 2024 (GB) 2413092.4

(51) Int. Cl. A63F 13/67; G06N 3/08

(52) U.S. Cl. CPC A63F 13/67; G06N 3/08

(57) ABSTRACT

Processing devices and methods for initiating interactions with non-player characters in a virtual environment. An example processing device includes a reception unit configured to receive one or more avatar properties associated with an avatar of a user; the reception unit is configured to receive one or more non-player character, NPC, properties associated with a given NPC; a calculation unit configured to calculate, in dependence upon the received avatar properties and the received NPC properties, a probability of the user desiring to initiate an interaction between the avatar and the given NPC; and an initiation unit configured to, in response to the calculated probability being above a predetermined threshold, automatically initiate the interaction between the avatar and the given NPC.

### CROSS-REFERENCE TO RELATED APPLICATION

This application claims priority to UK Patent Application No. GB2413092.4, filed Sep. 6, 2024, the content of which is herein incorporated by reference in its entirety for all purposes.

### TECHNICAL FIELD

The present disclosure relates to processing devices and methods. More specifically, the present disclosure relates to processing devices and methods for initiating interactions with non-player characters in a virtual environment.

### BACKGROUND

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present disclosure.

Modern virtual environments (e.g. those used for videogames) are often very complex and feature-rich. Virtual environments often include one or more non-player characters (NPCs), which a user may interact with in various ways, such interactions may include dialogue, trading, training, combat, etc.

Due to the rising complexity in virtual environments and the increases in available computing power, the quantity of interactable NPCs present in virtual environments is increasing. Consequently, it has become increasingly complex for a user to initiate interactions with a particular NPC - either requiring a complex series of inputs, or causing a high likelihood of accidentally initiating an unintended interaction with an NPC that is not the desired NPC.

There is therefore a need to reduce the complexity of user inputs required to initiate interactions with given NPCs.

It is in this context that the present disclosure arises.

### BRIEF DESCRIPTION OF THE DRAWINGS

Embodiments of the present disclosure will now be described by way of example with reference to the accompanying drawings, in which:

FIG. 1 schematically illustrates an example entertainment system.

FIG. 2 schematically illustrates an example processing device.

FIG. 3 schematically illustrates an example neural network.

FIG. 4 schematically illustrates an example method.

### DESCRIPTION OF THE EMBODIMENTS

In the following description, a number of specific details are presented in order to provide a thorough understanding of the embodiments of the present disclosure. It will be apparent, however, to a person skilled in the art that these specific details need not be employed to practice the present disclosure. Conversely, specific details known to the person skilled in the art are omitted for the purposes of clarity where appropriate.

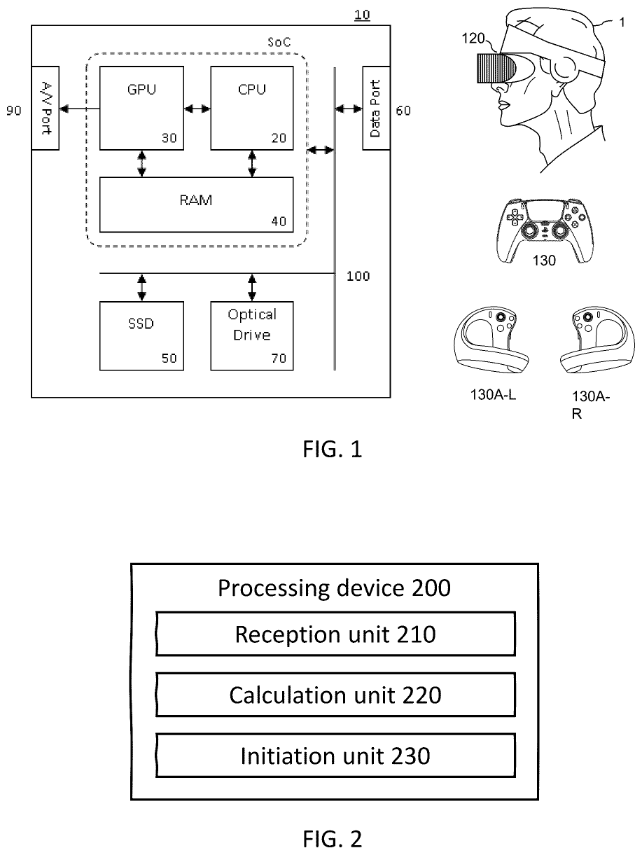

Referring to FIG. 1, an example of an entertainment system 10 is a computer or console.

The entertainment system 10 comprises a central processor or a central processing unit (CPU) 20. The entertainment system also comprises a graphical processing unit (GPU) 30, and random access memory (RAM) 40. Two or more of the CPU, GPU, and RAM may be integrated as a system on a chip (SoC).

Further storage may be provided by a disk 50, either as an external or internal hard drive, or as an external solid state drive, or an internal solid state drive.

The entertainment device may transmit or receive data via one or more data ports 60, such as a universal serial bus (USB) port, Ethernet® port, Wi-Fi® port, Bluetooth® port or similar, as appropriate. It may also optionally receive data via an optical drive 70.

Audio/visual (A/V) outputs from the entertainment device are typically provided through one or more A/V ports 90 or one or more of the data ports 60.

Where components are not integrated, they may be connected as appropriate either by a dedicated data link or via a bus 100.

An example of a device for displaying images output by the entertainment system is a head mounted display (HMD) 120, worn by a user 1.

Interaction with the system is typically provided using one or more handheld controllers 130, and/or one or more virtual reality (VR) controllers (130A-L, R) in the case of the HMD.

Due to the rising complexity in virtual environments and increases in available computing power, the quantity of interactable NPCs present in virtual environments is increasing. Consequently, it has become increasingly complex for a user to initiate interactions with a particular NPC—either requiring a complex series of inputs, or causing a high likelihood of accidentally initiating an unintended interaction with an NPC that is not the desired NPC.

There is therefore a need to reduce the complexity of user inputs which are required to initiate interactions with given NPCs.

Accordingly, turning now to FIG. 2, a processing device 200 for initiating interactions with non-player characters in a virtual environment is provided in accordance with embodiments of the present disclosure. The processing device 200 comprises a reception unit 210, a calculation unit 220, and an initiation unit 230. Each of these units 210, 220, 230 will now be discussed in turn.

The reception unit 210 is configured to receive one or more avatar properties associated with an avatar of a user.

The avatar of the user is a virtual representation of the user in a virtual environment and/or a virtual agent in a virtual environment that is controllable by the user. The one or more avatar properties associated with the avatar may be one or more properties that represent a current (and optionally a historical) state of the avatar.

Optionally, in some embodiments, one of the avatar properties may be avatar position data representative of a position of the avatar. For example, the avatar position data may be representative of the position of the avatar within a virtual environment. The avatar position data may also comprise height data that is representative of an elevation (or a in a case where the avatar is within a multi-storey building, a current storey of the avatar - such as lower ground, ground floor, first floor, etc.). The avatar position data may alternatively or additionally comprise data representative of a position of a field of view (FOV) of the avatar.

Optionally, in some embodiments, one of the avatar properties may be avatar movement data representative of a movement of the avatar. For example, the avatar movement data may be representative of a movement history of the avatar (e.g. historical avatar position data). Alternatively, or in addition, the avatar movement data may be representative of a current movement state of the avatar such as a speed and direction (i.e. velocity) of the avatar in the virtual environment. The avatar movement data may also be representative of a velocity of the avatar's FOV. The avatar movement data may alternatively or additionally comprise data representative of an acceleration of the avatar (it will be appreciated that an acceleration may include any change to a speed of the avatar such as an increase or a decrease to a speed of the avatar).

Optionally, in some embodiments, one of the avatar properties may be avatar task data representative of one or more tasks related to the avatar. For example, the avatar may be assigned one or more tasks (sometimes referred to as quests) to complete within a video game or a virtual environment. A task may be an in-game quest or objective; a so called “raid” event, dungeon or instance; achieving a particular trophy or achievement; acquiring a specific in-game item; reaching an in-game milestone such as achieving a certain avatar level or acquiring a threshold amount of an in-game item or currency; reaching a location or region in a virtual environment; or any other suitable task. Hence a task may be explicitly set (e.g. a quest) or simply acknowledged when achieved (e.g. a trophy). The avatar task data may be data representative of tasks that have been assigned to the avatar, the avatar's progress in respective tasks, the tasks for which the avatar meets the requirements to start and/or complete, etc. The avatar task data may also be indicate of one or more active or tracked tasks, which are tasks that are being actively performed by the avatar.

Optionally, in some embodiments, one of the avatar properties may be avatar relationship data indicative of a level of the avatar's opinion of at least one NPC. For example, avatar relationship data may be stored for every NPC in a video game or virtual environment. For a respective NPC, the avatar relationship data may be representative of a level of the avatar's opinion towards the respective NPC. For example, the avatar relationship data may comprise a single numerical value that is indicative of the avatar's overall opinion towards the respective NPC (e.g. from 0 to 100, where 0 is a low opinion, 50 is a neutral opinion and 100 is a good opinion). In some cases, the avatar relationship data may comprise several values that respectively indicate aspects of the avatar's opinion towards the NPC (e.g. a trust level, a respect level, a charisma level, etc.).

Notably, the avatar relationship data does not necessarily indicate a level of the respective NPC's opinion towards the avatar. For example, the avatar may have a high level of opinion towards a respective NPC but the respective NPC may have a relatively low opinion towards the avatar. The avatar relationship data may not be indicative of the respective NPC's low opinion towards the avatar. However, it will be appreciated that the avatar relationship data may optionally include data representative of a level of a respective NPC's opinion of the avatar.

In some cases, the avatar relationship data may also comprise data representative of a level of the avatar's opinion towards various categories of NPCs, which may be used to derive the avatar's default (i.e. initial) level of opinion towards a given NPC. Such categories of NPCs may, for example, include factions/teams (e.g. the blue kingdom, the red empire, pirates, etc.), professions (e.g. shop keeper, blacksmith, etc.), species (e.g. human, elf, orc, spooky skeleton, werewolf, etc.) or any other suitable category. As an example, an avatar may initially (i.e. before being modified in response to one or more actions performed by the avatar) have a high level of opinion towards NPCs from the same faction irrespective of any other factors, and a low level of opinion towards NPCs from the pirate faction, whilst having a neutral opinion towards NPCs from the remaining factions. Additionally, the avatar's initial opinion of an NPC may be boosted if they are the same species for example.

It will be appreciated that any other suitable type of data that may be representative of a level of an avatar's opinion towards a respective NPC may alternatively or additionally be used.

Optionally, in some embodiments, one of the avatar properties may be avatar inventory data may be representative of one or more items within the avatar's inventory. For example, the avatar may have an inventory that may store one or more items (such as equipment, weapons, trade goods, etc.).

Optionally, in some embodiments, one of the avatar properties may be avatar characteristic data representative of one or more characteristics of the avatar. For example, characteristics of the avatar may include the level of the avatar; the avatar's specialisation/build/role (e.g. healer, damage dealer (DPS), tank, etc.); the content of the avatar's inventory; whether the avatar has acquired a particular in-game item; whether the avatar has visited or has access to a particular area/location/region in a video game or virtual environment; the items equipped by the avatar; or any other suitable characteristic of the avatar.

It will be appreciated that the one or more avatar properties may alternatively or additionally comprise any other suitable properties that may be associated with the avatar.

The reception unit 210 is also configured to receive one or more non-player character, NPC, properties associated with a given NPC. The one or more NPC properties associated with the given NPC may be one or more properties that represent a current (and optionally a historical) state of the given NPC.

Optionally, in some embodiments, one of the NPC properties may be NPC position data representative of a position of the given NPC, which has been described, mutatis mutandis, in more detail elsewhere herein in regards to the avatar position data.

Optionally, in some embodiments, one of the NPC properties may be NPC movement data representative of a movement of the given NPC, which has been described, mutatis mutandis, in more detail elsewhere herein in regards to the avatar movement data.

Optionally, in some embodiments, one of the NPC properties may be NPC task data representative of one or more tasks related to the given NPC, which has been described, mutatis mutandis, in more detail elsewhere herein in regards to the avatar task data.

Optionally, in some embodiments, one of the NPC properties may be NPC relationship data indicative of a level of the given NPC's opinion of at least the avatar, which has been described, mutatis mutandis, in more detail elsewhere herein in regards to the avatar relationship data. It will also be appreciated that the NPC relationship data may optionally be indicative of a level of the given NPC's opinion towards one or more other NPCs.

Optionally, in some embodiments, one of the NPC properties may be NPC characteristic data representative of one or more characteristics of the given NPC, which has been described, mutatis mutandis, in more detail elsewhere herein in regards to the avatar characteristic data.

Optionally, in some embodiments, one of the NPC properties may be interactivity data indicative of a predefined interactivity level of the given NPC. The interactivity level of a respective NPC may be set in advance by a developer, or may be defined in dependence upon one or more characteristics of the respective NPC for example. An interactivity level of a respective NPC may be representative of what types of interactions an avatar may have with the respective NPC (e.g. dialogue, trading, training, combat, etc.).

For example, an NPC with a low interactivity level may not be able to engage in dialogue with an avatar (e.g. the NPC is a so-called ‘background’ NPC). An NPC with a slightly higher interaction level may be able to recite one or more predefined lines of dialogue to an avatar. An NPC with an even higher interaction level may have a dialogue tree, in which a user may select one or more different dialogue options for their avatar to use with the NPC, and the NPC may give a different response in dependence upon the dialogue option selected by the user. An NPC with an even higher interactivity level may be able to generate one or more dialogue responses using a LLM for example.

The above examples of interactivity levels all relate to a level of dialogue interactivity of an NPC. However, it will be appreciated that an interactivity level of a respective NPC may alternatively or additionally vary in other ways. For example, an interactivity level of an NPC may, at least in part, be based on a number or type of tasks related to the NPC. For example, an NPC that assigns or is involved in (e.g. as an objective) one or more tasks may have a higher interactivity level in comparison to an NPC that does not assign or is not involved in any tasks. Furthermore, if the tasks an NPC is involved with relate to a core task (e.g. a main story mission rather than a side quest) the interactivity level of the NPC may be set higher. If an NPC only relates to an optional aspect of a task (e.g. an optional objective or path), the NPC may be given a relatively lower interactivity level in comparison to an NPC that relates to a mandatory aspect of the task.

An interactivity level of a respective NPC may alternatively or additionally be set in dependence upon whether an NPC may participate in combat, join the avatar's party, and/or any other suitable factor that may be used for defining an interactivity level of an NPC.

It will also be appreciated that an interactivity level is not limited to being representative of an interactivity level for a single type of interaction available with an NPC. In some embodiments, an interactivity level of an NPC may be characterised by a combination of type interactivity levels for respective interaction types when a plurality of types of interaction are available with an NPC.

For instance, one type of interaction may be a trade interaction where the user's avatar may exchange one or more items with an NPC. One type interactivity level may therefore be a trade interactivity level, which may be representative of an interactivity level of a trade interaction with an NPC. In some cases, the trade interactivity level may simply be a binary representation of whether a trade interaction is available with an NPC. However, in some cases, the trade interactivity level may be further defined in dependence upon by one or more factors (such as quantity, quality, type, etc.) relating to items available to trade in a trade interaction with an NPC (such as the quantity, quality, type, etc. of items available to trade.

Another example of a type interactivity level may be a dialogue interactivity level representative of a level of interactivity of dialogue interactions with an NPC, as explained elsewhere herein. Yet another example of a type interactivity level may be a task interactivity level representative of a level of interactivity of task interactions with an NPC, as explained elsewhere herein.

In some cases, type interactivity levels may be summed to determine an overall interactivity level for an NPC. Alternatively, the largest type interactivity level may be used to determine an overall interactivity level. It will also be appreciated that the type interactivity levels may be weighted prior to, or as part of, determining the overall interactivity level. The weighting may be predefined for each type of interactivity level (e.g. task interactivity levels may be weighted higher than dialogue interactivity levels). Alternatively, one or more of the type interactivity levels may be used to weight one or more of the other type interactivity levels.

For example, a first NPC may have a dialogue interactivity level that is higher than a second NPC. Meanwhile, the second NPC may have a task interactivity level that is higher than the first NPC. In some cases, the dialogue interactivity level may be weighted in dependence upon the task NPC level (since task related dialogue may be deemed to be more important than non-task related dialogue for example). Accordingly, the second NPC may have a higher weighted dialogue interactivity level than the first NPC. The respective weighted dialogue interactivity level may in some cases be used as the overall interactivity level for each of the first and second NPCs. Alternatively, the respective weighted dialogue interactivity level may be combined with, compared to, used to weight, or be further weighted by one or more other respective type interactivity levels to determine the overall interactivity level for each of the first and second NPCs.

Optionally, in some embodiments, one of the NPC properties may be NPC inventory data representative of one or more items within the NPC's inventory, which has been described, mutatis mutandis, in more detail elsewhere herein in regards to the avatar inventory data.

In some embodiments, one or more of the avatar and/or NPC properties may be determined directly from the processing of the virtual environment. For example, one or more of the avatar and/or NPC properties may be read from a values stored in a memory that are used to define a state of, and/or process, the virtual environment.

Alternatively, or in addition, one or more of the avatar and/or NPC properties may be determined in dependence upon a video and/or audio output of the virtual environment. For example, one or more of the avatar and/or NPC properties may be determined base on an appearance of an avatar/NPC in a video output of the virtual environment. As an illustrative example, a trade interactivity level of an NPC may be identified based on audio of the trade NPC advertising their goods for sale.

Therefore, in some embodiments of the present disclosure, the reception unit 210 may be configured to receive a video and/or audio output of the virtual environment as data representative of one or more of the avatar properties and/or one or more of the NPC properties. In these embodiments, the reception unit 210 may be configured to identify the one or more of the avatar properties and/or the one or more of the NPC properties in dependence upon the received video and/or audio output of the virtual environment.

The calculation unit 220 is configured to calculate, in dependence upon the received avatar properties and the received NPC properties, a probability of the user desiring to initiate an interaction between the avatar and the given NPC.

Typically, a user may, for example, initiate an interaction between their avatar and an NPC by performing a sequence of one or more inputs with a control device. Optionally, the initiation of an interaction may also be dependent upon one or more criteria being fulfilled (e.g. a proximity between the user's avatar and the NPC being below a predetermined level, and/or the NPC being located substantially at the centre of the avatar's FOV), and/or in response to a prompt to begin interactions with the NPC. Alternatively, or in addition, a user may navigate one or more menus or UI elements in order to a select a given NPC and initiate an interaction between the given NPC and their avatar.

It will be appreciated that a user may desire to initiate an interaction with any number of NPCs, and it will also be appreciated that a user may also choose to not initiate an interaction with one or more NPCs. For example, the user may desire to initiate interactions with any NPC that is associated with a particular task, and avoid interactions with all other NPCs until that task is complete. As another example, a user may desire to interact with NPCs that respectively have one or more particular characteristics (e.g. are above a given character level), and avoid interactions with NPCs that do not possess the one or more particular characteristics (e.g. are below the given character level).

An example of the calculation unit 220 calculating a probability of the user desiring to initiate an interaction between the avatar and a given NPC in dependence upon the received avatar properties and the received NPC properties will now be described.

In this example, the received avatar properties and the received NPC properties may comprise avatar movement data and NPC movement data, which are described in more detail elsewhere herein. The NPC movement data may be indicative of the path the given NPC will take through the virtual environment. Meanwhile, the avatar movement data may indicate that the user has provided one or more inputs to control a movement of the avatar so that the avatar will intercept the given NPC on the NPC's path through the virtual environment. In dependence upon the indication of the inputs provided by the user, the calculation unit 220 may calculate that a probability of the user desiring to initiate an interaction between the avatar and the given NPC is high in comparison to a case where inputs provided by the user do not cause the avatar to intercept the given NPC, or in comparison to a case where the avatar will intercept the given NPC but the interception is not responsive to a controlled movement of the avatar by one or more inputs provided by the user (i.e. the interception is incidental).

Optionally, in some embodiments, the reception unit 210 may be configured to receive at least one set of one or more other NPC properties, a respective set of other NPC properties being associated with a respective other NPC. In these embodiments, the calculation unit 220 may be configured to calculate the probability in dependence upon the received avatar properties, the received NPC properties, and the at least one set of received other NPC properties.

As an example, a plurality of NPCs (i.e. a group of NPCs) may be proximate to one another in a virtual environment, and the avatar may be approaching the group or may already be proximate to the group (which may be indicated by received avatar movement data and received NPC position data of each of the NPCs). The received avatar properties may comprise avatar task data and the received NPC properties for each of the NPCs may comprise NPC task data. The avatar task data may indicate that a given task is currently being actively performed by the avatar (e.g. it is the task being tracked by the avatar or the avatar's recent progress in their assigned tasks relates to the given task). Meanwhile, the NPC task data of each of the NPCs in the group may indicate that only one of the NPCs is related the given task. In dependence upon this received data, the calculation unit 220 may calculate that the probability of the user desiring to initiate an interaction between the avatar and the particular NPC that is related to the given task is high in comparison to the other NPCs in the group.

It will be appreciated that the calculation unit may calculate the probability of the user desiring to initiate an interaction between the avatar and the given NPC using any other suitable relationship between the received avatar properties and the received NPC properties. For example, past avatar/NPC interaction data associated with one or more past avatar properties and one or more past given NPC properties may be used to identify what relationships between the past avatar properties and the past given NPC properties may be indicative of the user initiating an interaction between the given NPC and the avatar.

Optionally, in some embodiments of the present disclosure, the calculation unit 220 may comprise a machine learning model trained to predict a probability of the user desiring to initiate a respective interaction between a respective avatar and a respective NPC in dependence upon respective avatar properties and respective NPC properties.

For example, in some cases, the machine learning model may be trained using training data indicative of when a user initiates respective interactions between the avatar and a given NPC as well as one or more corresponding avatar properties and NPC properties. Such training data may be generated during gameplay of the video game.

In some cases, the trained machine learning model may be used to predict the probability of the user desiring to initiate a respective interaction between a respective avatar and a respective NPC in dependence upon respective avatar properties and respective NPC properties for respective avatar properties and respective NPC properties that are not part of the training data. For example, the machine learning model may be trained to learn from the training data associations between respective avatar properties and respective NPC properties based on features of the respective avatar properties and respective NPC properties in the training data. In these cases, when encountering new respective avatar properties and respective NPC properties, the trained machine learning model may determine the probability of the user desiring to initiate a respective interaction based on features of the new respective avatar properties and respective NPC properties that correspond to features learned during training.

In some embodiments of the present disclosure, a discriminative network may be utilised, in which the discriminative network is trained to determine a probability of the user desiring to initiate a respective interaction between a respective avatar and a respective NPC in dependence upon input data representative respective avatar properties and respective NPC properties.

For example, the discriminative network may be trained using a database of when a user initiated respective interactions between the avatar and a given NPC, and what the respective avatar properties and respective NPC properties were prior to, and when, the user initiating the respective interactions. In some cases, the database may additionally comprise a plurality respective first assets.

Alternatively, or in addition, a reinforcement learning model may be used in which a reward is determined based upon whether a user initiates an interaction or not when it is determined that there is a high/low probability of the user initiating an interaction.

For example, in a training phase of the reinforcement learning model, a reward function may provide rewards when a given interaction is calculated to have a high (or low) probability of being initiated by the user is actually initiated (or is not initiated) in dependence upon respective avatar and NPC properties during processing of the video game.

The training of models may be performed with any desired level of granularity in respect of the intended usage. For example, in some cases a model may be trained that is intended to be used to determine probabilities of the user desiring to initiate interactions in a specific game, while in other cases the model may be trained so as to instead be used for a series of games or an entire genre. Similarly, a model could be trained for a more specific purpose, such as for NPCs of a particular type.

Optionally, in some embodiments of the present disclosure, the training data may be recorded during gameplay of a plurality of users. Alternatively, the training data may be recorded during gameplay of a given user. In this case, the machine learning model may be trained for the given user. This may be advantageous, because the probabilities of the user desiring to initiate interactions in a specific game may be dependent upon an individual user's particular gameplay style.

While the above discussion has focused upon the use of a single trained model it may be considered advantageous to use a plurality of trained models. For instance, a first model may be used to predict probabilities for a first type of NPCs (e.g. hostile NPCs), whilst a second model may be used to may be used to predict probabilities for a second type of NPCs (e.g. friendly NPCs).

This can be advantageous in that the use of two separate models can enable a more specific training for specific types of NPCs, which can improve the predicted probabilities. Of course, more than two models could be used in a particular implementation - for instance, a third model could be used for a third type of NPCs (e.g. NPCs that may assign tasks).

Optionally, in some embodiments of the present disclosure, the machine learning model may be a neural network.

An example neural network would be a fully connected multi-layer perceptron, i.e. a fully connected multi-layer network having one or more hidden layers. Typically such a neural network operates as a feedforward neural network, trained using a backpropagation algorithm to approximate target outputs in response to corresponding inputs. More generally the neural network can be implemented as a fully connected neural network, a deep neural network (DNN), multilayer perceptron (MLP), feedforward artificial neural network (ANN), or a convolutional neural network (CNN, or ConvNet).

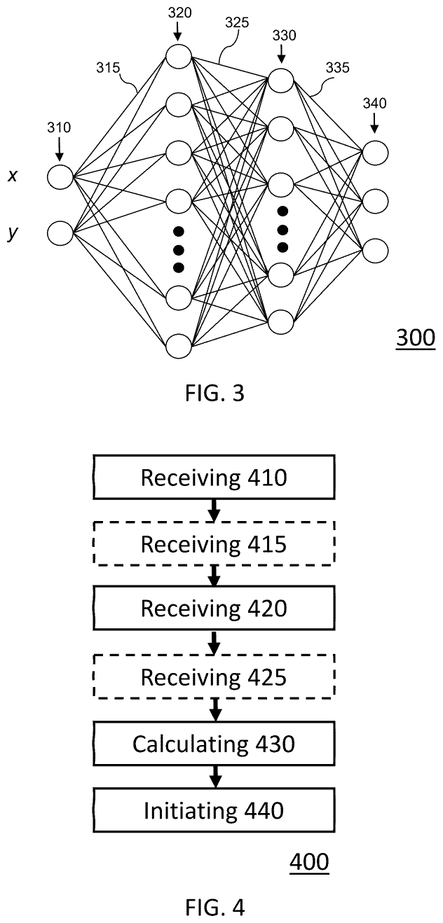

Turning now to FIG. 3, an example neural network 300 comprises an input node layer 310, an output node layer 340 and one or more hidden layers 320, 330. The hidden layers may comprise any suitable number of nodes. Between each layer are typically a fully connected set of weights 315, 325, 335; that is to say there is a weight between each node in adjoining layers. However, optionally the network does not need to be fully connected in this manner, and so some weights may not be included.

In embodiments of the present description, a first input node (x) may be representative of an avatar property received by the reception unit 210 (such as avatar movement data or avatar task data), and a second input node (y) may be representative of an NPC property (such as NPC movement data, etc.). The neural network may have one or more output nodes, which may indicate a probability of the user desiring to initiate an interaction between the avatar and a given NPC.

The neural network may optionally comprise one or more other input nodes that may, for example, be representative of one or more additional avatar properties, one or more additional NPC properties, one or more other properties that may be received by the reception unit 210 (as described elsewhere herein), and/or any other suitable parameter that may be indicated by one of the input nodes.

In some embodiments of the present disclosure, a loss function for the neural network may be calculated by using information indicative of whether the user actual initiated an interaction as a ground truth.

The training may continue until an error criterion is met, such as a total error is below a threshold amount (indicating that a predefined quality/accuracy level has been met), or when a total or average error has not changed by a threshold amount after M training iterations (i.e. the neural network has likely achieved its best available outcome for the current training process, or that subsequent training iterations will represent a sufficiently small return on computational investment that they should not be continued).

Once trained, the neural network comprises an internal representation within its weights of how to translate an input representative of one or more respective avatar properties and one or more respective NPC properties into a probability of the user desiring to initiate a respective interaction between a respective avatar and a respective NPC.

Whilst specific examples for the type of machine learning model have been given above, the machine learning model is not limited to these examples and any other appropriate type of machine learning model may be used.

In embodiments of the present disclosure, a machine learning model for initiating interactions with non-player characters in a virtual environment is provided. The machine learning model is trained to receive an input comprising one or more avatar properties associated with an avatar of a user, and one or more non-player character, NPC, properties associated with a given NPC; and output a probability of the user desiring to initiate an interaction between the avatar of the user and the given NPC.

Additionally, in embodiments of the present disclosure, a method of training a machine learning model for initiating interactions with non-player characters in a virtual environment according to the machine learning models described elsewhere herein is provided.

Returning to FIG. 2, the initiation unit 230 is configured to, in response to the calculated probability being above a predetermined threshold, automatically initiate the interaction between the avatar and the given NPC.

As an example, the initiation unit 230 may automatically initiate the interaction by issuing one or more software instructions. Alternatively, the initiation unit 230 may generate one or more input signals (that are equivalent to input signals that can be provided by a user) to automatically initiate the interaction. It will be appreciated that any other suitable technique for automatically initiating the interaction may be used.

In some embodiments, the predetermined threshold may be set by a developer or by the user. As an example, the predetermined threshold may set to 70% by the user. In this example, when the calculation unit 220 calculates that a probability of the user desiring to initiate an interaction between the avatar and a given NPC is above 70%, the initiation unit 230 may automatically initiate the interaction between the avatar and the given NPC. It will of course be appreciated that the predetermined threshold may be set at any particular level such as 25%, 36%, 50%, 60%, 75%, 90%, 95%, 99%, etc.

It will be appreciated that the automatic initiation that is performed by the initiation unit 230 may be performed without any additional input from the user. Therefore, the processing device may enable a user to automatically initiate interactions with NPCs without having to provide an input to initiate such interactions. Therefore, the processing device may reduce the number of input controls that are needed by a user to interact with a video game or virtual environment.

In embodiments of the present disclosure where the video game is being executed at a server and the processing device is comprised by the server, the present approach further allows reducing instances of input latency since the server would not need to wait for an input from a client device to initiate an interaction.

Further optionally, in embodiments of the present disclosure where the machine learning model may be a neural network, the predetermined threshold may be an activation function of the output neuron of the neural network, and a level of the activation may be set during the training of the neural network to predict the probability of the user desiring to initiate a respective interaction between a respective avatar and a respective NPC.

Optionally, in some embodiments of the present disclosure, a level of the predetermined threshold may vary based on at least one calculated probability of the user desiring to initiate an interaction between the avatar and a respective other NPC, the at least one calculated probability previously calculated in dependence upon the received avatar properties and a respective set of one or more other NPC properties associated with the respective other NPC. In other words, the respective probabilities calculated by the calculation unit 220 for other NPCs may vary the level of the predetermined threshold.

For example, the calculation unit 220 may calculate respective probabilities of the user's desire to interact with respective NPCs in parallel. If the calculation unit 220 calculates that the probability for a first NPC is above the predetermined threshold, the predetermined threshold may be set to the calculated probability for the first NPC. Therefore, if the respective probabilities calculated for the other NPCs are all less than the new threshold (i.e. the calculated probability for the first NPC), the initiation unit 230 may initiate an interaction between the avatar and the first NPC, but will not initiate an interaction for any of the other NPCs, since their respective probabilities will be below the varied threshold.

However, if a probability calculated for a second NPC is above the varied threshold, the threshold may be varied again by setting the threshold to the probability calculated for the second NPC. In this case, the initiation unit 230 may initiate an interaction between the avatar and the second NPC, but will not initiate an interaction for any of the other NPCs (including the first NPC), since their respective probabilities will be below the varied threshold.

Optionally, in some embodiments of the present disclosure, the initiation unit 230 may be configured to, in response to the calculated probability being above the predetermined threshold, automatically initiate the interaction by initiating a dialogue between the avatar and the given NPC

Optionally, in some embodiments of the present disclosure, the reception unit 210 may be configured to receive one or more user properties associated with the user. In these embodiments, the calculation unit 220 may be configured to calculate the probability in dependence upon the received avatar properties, the received NPC properties, and the received user properties.

The one or more user properties may be indicative of one or more characteristics of the user. For example, the number of trophies/achievements a user has/has not obtained; whether a user has/has not obtained a particular trophy/achievement; a user's total play time; a user's average session length; or any other suitable characteristics.

Alternatively, or in addition, one of the user properties may be indicative of the user's overall likelihood to initiate interactions with NPCs. For example, some users may wish to interact with nearly all NPCs they encounter whilst other users may wish to interact with as few NPCs as possible. Therefore, based on, for example, a given user's historical interaction history with one or more NPCs, an indication of the user's overall likelihood to initiate interactions with NPCs may be derived. The calculation unit 220 may then use this overall likelihood when calculating the probability (e.g. as a scaling factor between 0 and 1 to the probability calculated using just the avatar properties and NPC properties).

Therefore, at least one of the user properties may be indicative of a likelihood of the user initiating a respective interaction between the avatar and the given NPC relative to a respective likelihood of one or more other users initiating the respective interaction between the avatar and the given NPC.

It will be appreciated that, as discussed in more detail elsewhere herein, there may be a plurality of types of interactions that can be performed between the avatar and a given NPC (such as trade interactions, dialogue interactions, task interactions, combat interactions, etc.). Therefore, in some cases, it may be desirable to not only automatically initiate an interaction in accordance with the present disclosure, but to also assist the user in performing a desired type of interaction from the plurality of interaction types.

Therefore, in some embodiments of the present disclosure, the calculation unit 220 may be configured to calculate, for a plurality of types of interaction, a respective probability of the user desiring to perform a respective type of interaction between the avatar and the given NPC, in dependence upon the received avatar properties and the received NPC properties.

The calculation of respective probabilities of the user desiring to perform respective types of interaction may performed in the same manner as the calculation of the probability of the user desiring to initiate an interaction, as described elsewhere herein.

In these embodiments, the initiation unit 230 may be configured to automatically initiate the interaction by automatically performing the type of interaction based on the respective probabilities calculated for the corresponding types of interaction. For example, automatically performing the type of interaction that is associated with the highest one of the respective probabilities.

Alternatively, the initiation unit 230 may be configured to automatically initiate the interaction by providing the user with a plurality of user selectable interaction options that respectively correspond to the plurality of types of interactions, and are ranked based on the respective probabilities calculated for the corresponding types of interaction. In this case, a user selection of a respective interaction option may cause the initiation unit 230 to cause avatar to perform the corresponding type of interaction with the given NPC (e.g. by issuing one or more software instructions or generating one or more input signals, as described elsewhere herein).

In this case, the interaction option corresponding to the type of interaction that is associated with the highest one of the respective probabilities may, for example, be provided to the user in the most prominent manner in comparison to the other interaction options (such as at the top of, or initial element of, a list). The interaction option corresponding to the type of interaction that is associated with the next highest one of the respective probabilities may, for example, be provided to the user in the next most prominent manner in comparison to the remaining interaction options, and so on. It will be appreciated that only some of the possible interaction options need to be provided to the user.

For example, only the interaction options that correspond to the types of interaction associated a predetermined number of the highest respective probabilities may be provided. As another example, all of the interaction options that correspond to the types of interaction associated with respective probabilities above a predetermined threshold may be provided to the user. The predetermined threshold may be set in the same manner as the predetermined threshold for automatically initiating the interaction, as described elsewhere herein.

As an illustrative example, it may be possible to perform both trade, task and dialogue interactions with a given NPC. The calculation unit 220 may be configured to calculate, for each of these types of interaction, a respective probability of the user desiring to perform each type of interaction between the avatar and the given NPC (i.e. a trade probability, task probability, and dialogue probability).

The initiation unit may automatically initiate the interaction by providing the user with a plurality of user selectable interaction options, that each correspond to one of the types of interactions (i.e. a trade interaction option, a task interaction option, and a dialogue interaction option). Each of these options may be ranked based on their respectively calculated probability. In response to the user selecting one of these options, the associated interaction may be performed.

Optionally, in some embodiments of the present disclosure, the interaction to be initiated may be modified in response to (i.e. in dependence on) the calculated probability. For example, if the interaction is a dialogue interaction, and in a case where the calculated probability is above the predetermined threshold to automatically initiate the interaction but below a second, higher predetermined threshold, the dialogue interaction may be modified in order to reduce a duration of the dialogue interaction. Alternatively, or in addition, a difficulty of a task or combat interaction may be modified in dependence on the calculated probability of the user desiring to initiate an interaction between the avatar and the given NPC. For instance, if the calculated probability is higher (e.g. above a higher predetermined threshold), a higher difficulty may be set for the task or combat. Modifying the interaction in dependence on the calculated probability advantageously allows improving user engagement by tailoring interactions based on the user's expected interest in the interactions.

In alternative arrangements of the present disclosure, the present techniques may be applied in order to automatically initiate interactions between the avatar of the user and a given interactable virtual element.

An interactive virtual element may be any feature of a virtual environment that may be interacted with by the avatar. For example, an interactive virtual element may be a virtual asset, such as a virtual item, a power-up, health pickup, ammo pickup, etc. ; a portion of a virtual environment, such as a door or window, a lever or button, a climbable terrain element, etc. ; another user's avatar; a virtual projectile such as a spell or an arrow; an NPC as described elsewhere herein; and/or any other element of a virtual environment that may be interacted with by the avatar.

In these cases, the above described techniques may use one or more element properties associated with the interactive virtual element instead of one or more NPC properties (although the element properties may be NPC properties in a case where the interactive virtual element is an NPC).

The one or more element properties associated with the given interactive virtual element (which may also be referred to as the given element) may be one or more properties that represent a current (and optionally a historical) state of the given element.

Optionally, in some embodiments, one of the element properties may be element position data representative of a position of the given element, which has been described, mutatis mutandis, in more detail elsewhere herein in regards to the avatar position data.

Optionally, in some embodiments, one of the element properties may be element movement data representative of a movement of the given element, which has been described, mutatis mutandis, in more detail elsewhere herein in regards to the avatar movement data.

Optionally, in some embodiments, one of the element properties may be element task data representative of one or more tasks related to the given element, which has been described, mutatis mutandis, in more detail elsewhere herein in regards to the avatar task data.

Optionally, in some embodiments, one of the element properties may be element characteristic data representative of one or more characteristics of the given element. For example, if the given element is a health pickup, the element characteristic data may be indicative of an amount of health of the user's avatar will be restored by the health pickup, whether the health pickup respawns (and if so, how long it takes for the health pickup to respawn), etc. As another example, if the given element is a virtual item that may be equipped by the user's avatar, the characteristic data may be indicative of the properties of the virtual item when equipped by the avatar, such as an amount of damage done by the virtual item, an amount of defence provided by the virtual item, a special ability made available to the avatar when the virtual item is equipped, etc. As a further example, if the given element is a lever, the characteristic data may be indicative of what is controlled by the operation of the lever, such as what doors are opened when the lever is pulled.

An illustrative example of the present techniques applied in order to automatically initiate interactions between the avatar of the user and a given interactable virtual element will now be described. In this example, the given interactive element may be a health pickup that, when interacted with by the avatar, will restore a predetermined amount of health to the avatar. The predetermined amount of health restored may be a fixed amount of hit points (such as ten hit points), a proportion of the avatar's total maximum hit points (such as up to 50% of the avatar's total maximum hit points), a proportion of the difference between the avatar's current and total maximum hit points (the pickup may restore more hit points when the avatar has lost more of its total hit points in comparison to a case where the avatar has lost less of its total hit points), or even all of an avatar's hit points.

In this example, one or more of the avatar properties received by the reception unit 210 may be indicative of the total maximum amount of hit points of the avatar and the current hit points of the avatar. Meanwhile, one or more of the element properties associated with the health pickup may be indicative of the amount of health restored by the pickup, and whether the health pickup respawns (and if so, how long it takes for the health pickup to respawn).

In this example, the calculation unit 220 may calculate, in dependence upon the received avatar properties and the received element properties, a probability of the user desiring to initiate an interaction between the avatar and the health pickup.

For example, if the avatar properties indicate that the avatar is at substantially full health (e.g. the current hit points of the avatar are, for example, above 95% of the avatar's total maximum hit points), the calculation unit 220 may calculate that the probability of the user desiring to initiate an interaction between the avatar and the health pickup to be low. Similarly, if the difference between difference between the avatar's current and total maximum hit points (which may also be referred to as the amount of missing hit points) is greater than an amount of hit points restored by the health pickup (in a case when the amount of hit points restored by the pickup is not dependent upon the avatar's current hit points), the calculation unit 220 may calculate that the probability of the user desiring to initiate an interaction between the avatar and the health pickup to be high.

In a case where the avatar has, for example, at least 75% of its hit points remaining (and the health pickup restores more than 25% of the avatar's health or is proportional to the amount of missing hit points), the calculated probability may be high when the element properties indicate that the pickup respawns (since using the pickup when some if its effect would be wasted would not prevent a later use of the pickup) and low when the element properties indicate that the pickup does not respawn. Additionally, in the case where the pickup respawns, the calculated probability may be higher when the respawn time for the pickup is short in comparison to a case where the respawn time is long.

In response to the calculated probability being above a predetermined threshold, the initiation unit 230 may automatically initiate the interaction between the avatar and the health pickup as described elsewhere herein.

In some embodiments of the present disclosure, the processing device 200 may be comprised by an entertainment device such as entertainment device 10, or may be communicating with an entertainment device. In these cases, the reception unit 210 may be configured to receive one or more of the various properties described herein (e.g. the one or more avatar properties and/or the one or more NPC properties) from the entertainment device 10 (such as from any one of the processor 20, GPU 30, or RAM 40).

Alternatively, or in addition, a video game may be streamed to a client device from a server (or an entertainment device) that is rendering the video game. In these cases, the processing device 200 may be comprised by the server or the client device. In case where the processing device 200 is comprised by server, instances of input latency between the client device and the server may advantageously be reduced since the processing device 200 may reduce the need for a user to provide inputs to the server via the client device in order to initiate interactions with NPCs.

It will also be appreciated that the receipt by the reception unit 210 of one or more of the various properties as described elsewhere herein may be achieved by only transmitting changes of the various properties to the reception unit 210, and the reception unit 210 may apply these changes to a stored version of the various properties that have been previously received by the reception unit 210.

It will be appreciated that, in some embodiments of the present disclosure, the processing device 200 may be provided independently of a particular entertainment device rendering a virtual environment.

For example, as described elsewhere herein, one or more of the avatar and/or NPC properties may be determined in dependence upon a video and/or audio output of the virtual environment. In such cases, the reception unit 210 may receive, as data representative of the one or more avatar and/or NPC properties, the video and/or audio output of the virtual environment output by the entertainment device.

In these cases, the reception unit 210 may identify the one or more avatar and/or NPC properties in dependence upon the video and/or audio output of the virtual environment, as explained elsewhere herein. It will be appreciated however that another device or unit may alternatively perform the identification of the one or more avatar and/or NPC properties in dependence upon the video and/or audio output of the virtual environment, and the result of said identification may be provided to the reception unit 210.

Additionally, in order to initiate the interaction, the initiation unit 230 may provide one or more control inputs to the entertainment device to automatically initiate the interaction between the avatar and a given NPC, where the control inputs are equivalent to the control inputs that may be provided by a user for interaction with the virtual environment as described elsewhere herein.

It will be appreciated that in these cases, both the entertainment device and the virtual environment would not need to be designed to operate with the processing device 200, since the actions of the processing device may be equivalent to actions that would be performed by a user (such as providing control inputs).

Turning now to FIG. 4, in embodiments of the present disclosure, a method 400 of initiating interactions with non-player characters is provided. The method comprises the steps of: receiving 410 one or more avatar properties associated with an avatar of a user; receiving 420 one or more non-player character, NPC, properties associated with a given NPC; calculating 430, in dependence upon the received avatar properties and the received NPC properties, a probability of the user desiring to initiate an interaction between the avatar and the given NPC; and in response to the calculated probability being above a predetermined threshold, automatically initiating 440 the interaction between the avatar and the given NPC.

Optionally (as indicated by the dotted outline in FIG. 4), in some embodiments of the present disclosure, the method 400 may comprise a step of receiving 415 one or more user properties associated with the user. In these embodiments, the step of calculating 430 comprises calculating the probability in dependence upon the received avatar properties, the received NPC properties, and the received user properties

Optionally (as indicated by the dotted outline in FIG. 4), in some embodiments of the present disclosure, the method 400 may comprise a step of receiving 425 at least one set of one or more other NPC properties, a respective set of other NPC properties being associated with a respective other NPC. In these embodiments, the step of calculating 430 comprises calculating the probability in dependence upon the received avatar properties, the received NPC properties, and the at least one set of received other NPC properties

Modifications to the method 400 corresponding to the modifications described elsewhere herein will be apparent to the skilled person.

It will be appreciated that the above methods may be carried out on conventional hardware suitably adapted as applicable by software instruction or by the inclusion or substitution of dedicated hardware.

Thus the required adaptation to existing parts of a conventional equivalent device may be implemented in the form of a computer program product comprising processor implementable instructions stored on a non-transitory machine-readable medium such as a floppy disk, optical disk, hard disk, solid state disk, PROM, RAM, flash memory or any combination of these or other storage media, or realised in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

Accordingly, in a summary embodiment of the present description, the processing device 200 may be implemented on, for example, a server (not shown) or entertainment device 10.

Instances of this summary embodiments implementing the methods and techniques described herein (for example by use of suitable software instruction) are envisaged within the scope of the application.

The foregoing discussion discloses and describes merely exemplary embodiments of the present disclosure. As will be understood by those skilled in the art, the present disclosure may be embodied in other specific forms without departing from the spirit or essential characteristics thereof. Accordingly, the disclosure of the present disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

1. A processing device comprising:
one or more memory devices configured to store instructions; and
one or more processors, that upon execution of the instructions, are configured to:
receive one or more avatar properties associated with an avatar of a user;
receive one or more non-player character (NPC) properties associated with a given NPC;
calculate, in dependence upon the received avatar properties and the received NPC properties, a probability of the user desiring to initiate an interaction between the avatar and the given NPC; and
in response to the calculated probability being above a predetermined threshold, automatically initiate the interaction between the avatar and the given NPC.

2. The processing device according to claim 1, wherein the one or more processors are further configured to:
predict, using a machine learning model, the probability in dependence upon respective avatar properties and respective NPC properties.

3. The processing device according to claim 2, wherein
the machine learning model is a neural network,
the predetermined threshold is obtained as an activation function of the output neuron of the neural network, and
wherein a level of the activation function is set during training of the neural network.

4. The processing device according to claim 1, wherein
a level of the predetermined threshold varies based on at least one calculated probability of the user desiring to initiate an interaction between the avatar and a respective other NPC, the at least one calculated probability previously calculated in dependence upon the one or more avatar properties and a respective set of one or more other NPC properties associated with the respective other NPC.

5. The processing device according to claim 1, wherein the one or more processors are further configured to:
receive one or more user properties associated with the user; and
calculate the probability in dependence upon the one or more avatar properties, the one or more NPC properties, and the one or more user properties.

6. The processing device according to claim 5, wherein
at least one of the one or more user properties are indicative of a likelihood of the user initiating a respective interaction between the avatar and the given NPC relative to a respective likelihood of one or more other users initiating the respective interaction between the avatar and the given NPC.

7. The processing device according to claim 1, wherein the one or more processors are further configured to:
receive at least one set of one or more other NPC properties, a respective set of other NPC properties being associated with a respective other NPC; and
calculate the probability in dependence upon the received avatar properties, the received NPC properties, and the at least one set of received other NPC properties.

8. The processing device according to claim 1, wherein
the one or more processors are configured to, in response to the calculated probability being above the predetermined threshold, automatically initiate the interaction by initiating a dialogue between the avatar and the given NPC.

9. The processing device according to claim 1, wherein the one or more processors are further configured to:
calculate, for a plurality of types of interaction, a respective probability of the user desiring to perform a respective type of interaction between the avatar and the given NPC, in dependence upon the received avatar properties and the received NPC properties; and
automatically initiate the interaction by providing the user with a plurality of user selectable interaction options, respectively corresponding to the plurality of types of interactions, that are ranked based on the respective probabilities calculated for the corresponding types of interaction, where a user selection of a respective interaction option causes the initiation unit to cause the avatar to perform the corresponding type of interaction with the given NPC.

10. The processing device according to claim 1, wherein
the avatar properties comprise one or more of the avatar properties from the list comprising:
avatar position data representative of a position of the avatar;
avatar movement data representative of a movement of the avatar;
avatar task data representative of one or more tasks related to the avatar;
avatar relationship data indicative of a level of the avatar's opinion of at least the given NPC; and
avatar inventory data representative of one or more items within the avatar's inventory.

11. The processing device according to claim 1, wherein
the NPC properties comprise one or more of the NPC properties from the list comprising:
NPC position data representative of a position of the given NPC;
NPC movement data representative of a movement of the given NPC;
NPC task data representative of one or more tasks related to the given NPC;
NPC relationship data indicative of a level of the given NPC's opinion of at least the avatar;
NPC interactivity data indicative of a predefined interactivity level of the given NPC; and
NPC inventory data representative of one or more items within the NPC's inventory.

12. The processing device according to claim 1, wherein the one or more processors are further configured to:
receive a video and/or audio output of the virtual environment as data representative of one or more of the avatar properties and/or one or more of the NPC properties; and
identify the one or more of the avatar properties and/or the one or more of the NPC properties in dependence upon the received video and/or audio output of the virtual environment.

13. A method comprising:
receiving one or more avatar properties associated with an avatar of a user;
receiving one or more non-player character, NPC, properties associated with a given NPC;
calculating, in dependence upon the received avatar properties and the received NPC properties, a probability of the user desiring to initiate an interaction between the avatar and the given NPC; and
in response to the calculated probability being above a predetermined threshold, automatically initiating the interaction between the avatar and the given NPC.

14. A non-transitory, computer-readable storage medium containing a computer program, which when executed by a computer, causes the computer to carry out actions, comprising:
receiving one or more avatar properties associated with an avatar of a user;
receiving one or more non-player character, NPC, properties associated with a given NPC;
calculating, in dependence upon the received avatar properties and the received NPC properties, a probability of the user desiring to initiate an interaction between the avatar and the given NPC; and
in response to the calculated probability being above a predetermined threshold, automatically initiating the interaction between the avatar and the given NPC.
